(19) United States
(12) Patent Application Publication
(10) Pub. No.: US 2025/0243693 A1
(43) Pub. Date: Jul. 31, 2025

(54) DOOR LOCK KIT, DOOR FRAME LOCK KIT, AND MAGNETIC DOOR LOCK WITH THE SAME

(71) Applicant: FIBRE INDUSTRY CO., LTD., Hsinchu City (TW)

(72) Inventor: Chen-Yu HUNG, Hsinchu City (TW)

(21) Appl. No.: 18/921,165

(22) Filed: Oct. 21, 2024

(30) Foreign Application Priority Data
Jan. 29, 2024 (TW) 113103309

(51) Int. Cl. E05B 47/00; E05B 63/00

(52) U.S. Cl. CPC E05B 47/004; E05B 63/0017

(57) ABSTRACT

A magnetic door lock includes a door lock kit and a door frame lock kit. The door lock kit includes a deadbolt having a retaining slidable sleeve disposed in a deadbolt guiding slot in a housing, and a magnet disposed in the sleeve. The deadbolt is operable to slide between a locking position, where a retaining end of the sleeve projects outwardly from the housing, and an unlocking position, where the retaining end retreats into the slot. A driving member is operable to drive the deadbolt to slide from the locking position to the unlocking position. The door frame lock kit includes a lock frame and a magnet which is magnetically attracted to the magnet to urge the deadbolt to slide into the lock frame in the locking position.

### CROSS-REFERENCE TO RELATED APPLICATION

This application claims priority to Taiwanese Patent Application No. 113103309, filed on Jan. 29, 2024, and incorporated by reference herein in its entirety.

### FIELD

The disclosure relates to a door lock, and more particularly to a magnetic door lock with a slidable deadbolt through a magnetic force.

### BACKGROUND

Conventional door locks have many components, thereby causing problems such as inconvenient fabrication, complicated construction and high manufacturing costs. Moreover, the deadbolt of a conventional door lock is prone to generate noises due to collision during the locking process, which results in discomfort and distress to users.

### SUMMARY

Therefore, an object of the disclosure is to provide a door lock kit, a door frame lock kit and a magnetic door lock that can alleviate at least one of the drawbacks of the prior art.

According to a first aspect of the disclosure, the door lock kit includes a housing, a deadbolt and a driving member. The housing is formed with a deadbolt guiding slot therein, and an opening in communication with the deadbolt guiding slot. The deadbolt includes a retaining slidable sleeve which is slidably disposed in the deadbolt guiding slot and which has a retaining end that faces toward the opening, and a magnet which is disposed in the retaining slidable sleeve. The deadbolt is operable to slide relative to the housing between a locking position, where the retaining end of the retaining slidable sleeve projects outwardly from the opening, and an unlocking position, where the retaining end retreats into the deadbolt guiding slot. The driving member is motionably disposed in the deadbolt guiding slot and is operable by an external force to drive the deadbolt to slide from the locking position to the unlocking position.

According to a second aspect of the disclosure, the door frame lock kit includes a lock frame and a magnet. The lock frame includes a locking plate and a receptacle cooperatively defining a front receiving slot therein. The locking plate has a first long side edge and a second long side edge opposite to each other. The receptacle extends from the locking plate and is spaced apart from the first long side edge and the second long side edge. The receptacle defines a center which is distant from the first long side edge by a first distance, and which is distant from the second long side edge by a second distance. The first distance is larger than the second distance. The magnet is disposed in the receptacle.

According to a third aspect of the disclosure, the magnetic door lock includes the abovementioned door lock kit and the abovementioned door frame lock kit. The magnet of the door frame lock kit is magnetically attracted to the magnet of the deadbolt to urge the retaining slidable sleeve of the deadbolt to slide into the front receiving slot in the locking position.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a perspective view illustrating an embodiment of a magnetic door lock according to the disclosure.

FIG. 2 is a fragmentary sectional view illustrating the embodiment mounted on a door panel and a door frame and a deadbolt of the embodiment in a locking position.

FIG. 3 is an exploded perspective view illustrating a door lock kit of the embodiment.

FIG. 4 is a fragmentary side view of the embodiment, illustrating the deadbolt in the locking position.

FIG. 5 is a sectional view taken along line V-V of FIG. 4.

FIG. 6 is a fragmentary side view of the embodiment, illustrating the deadbolt in an unlocking position.

FIG. 7 is an exploded perspective view illustrating a door frame lock kit of the embodiment and the door frame.

FIG. 8 is an exploded perspective view of the door frame lock kit of the embodiment.

FIG. 9 is an exploded perspective view of the door frame lock kit, taken from another angle.

FIG. 10 is a fragmentary side view illustrating the door frame lock kit and the door frame.

FIG. 11 is a fragmentary side view illustrating the door frame lock kit and the door frame in another assembled mode.

FIG. 12 is a fragmentary sectional view illustrating the embodiment mounted on the door panel and the door frame, and the deadbolt in the locking position.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly. In the following description, a first horizontal direction (D1), a second horizontal direction (D2) and a vertical direction (D3) are transverse to one another. The first horizontal direction (D1) is substantially a front-rear direction of the magnetic door lock 100, the second horizontal direction (D2) is substantially a left-right direction of the magnetic door lock 100, and the vertical direction (D3) is substantially an up-down direction of the magnetic door lock 100.

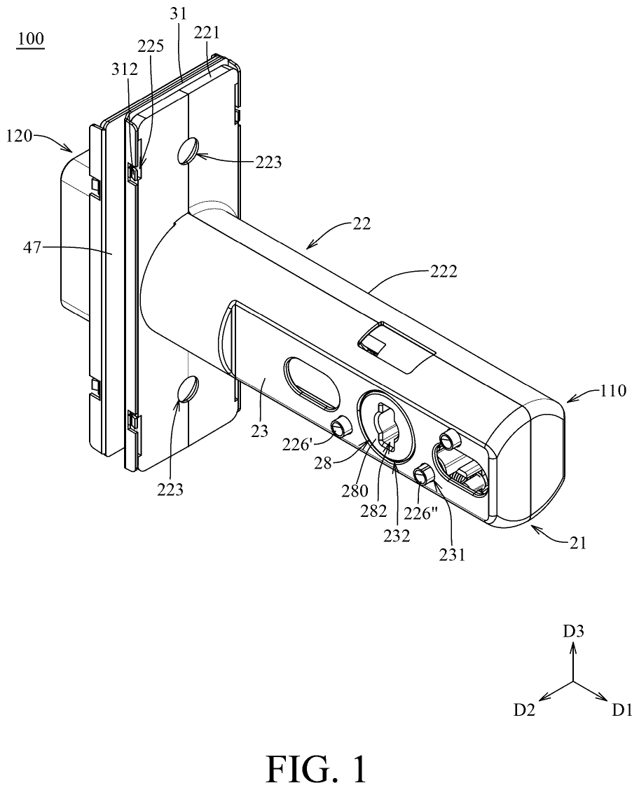

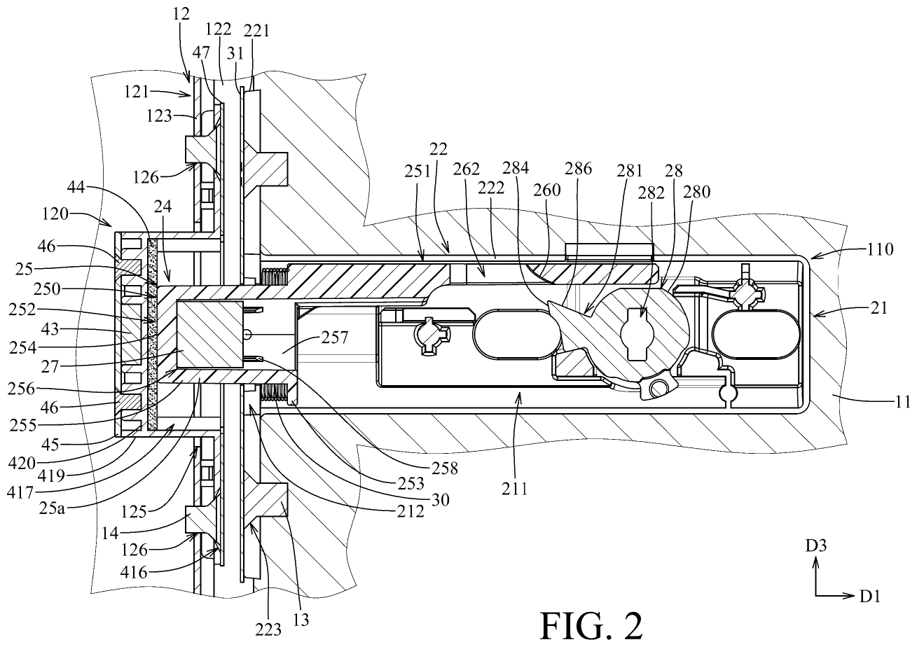

Referring to FIGS. 1 and 2, an embodiment of a magnetic door lock 100 according to the disclosure includes a door lock kit 110 and a door frame lock kit 120.

With reference to FIGS. 1, 2 and 7, the door lock kit 110 is adapted to be mounted on a door panel 11, and the door frame lock kit 120 is adapted to be mounted on a door frame 12. The door frame 12 has a frame body 121 and a rubber strip 122 disposed on the frame body 121. The frame body 121 has an upright side wall 123 extending in the vertical direction (D3), and an upright end wall 124 connected with the upright side wall 123 and extending in the vertical direction (D3). The upright side wall 123 is formed with a mounting hole 125 and two screw holes 126 respectively formed at upper and lower sides of the mounting hole 125. The rubber strip 122 is disposed on the end wall 124 to contact the door panel 11 for shock absorbing purposes during closing of the door panel 11.

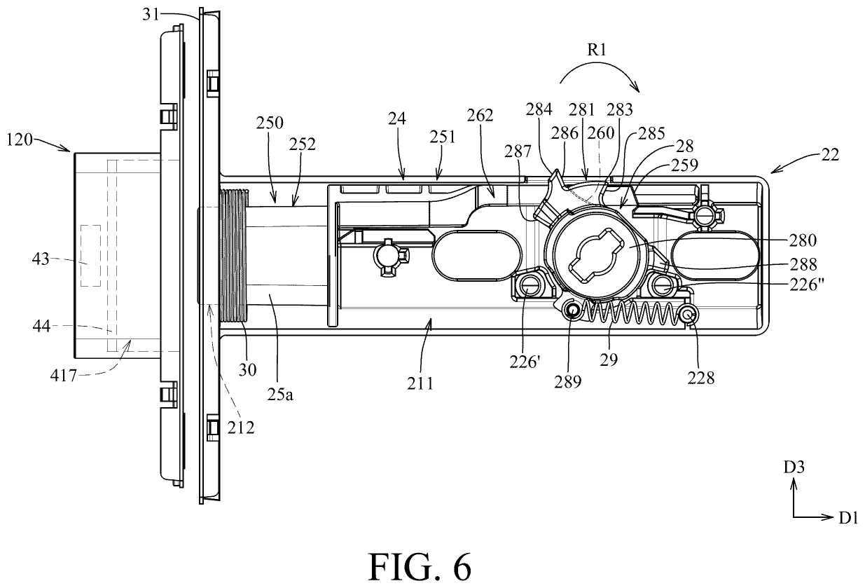

With reference to FIGS. 1, 2 and 3, the door lock kit 110 includes a housing 21, a deadbolt 24 and a driving member 28. The housing 21 is mounted on the door panel 11, and is formed with a deadbolt guiding slot 211 therein, and an opening 212 in communication with the deadbolt guiding slot 211. The deadbolt 24 includes a retaining slidable sleeve 25 which is slidably disposed in the deadbolt guiding slot 211 and which has a retaining end (25a) that faces toward the opening 212, and a magnet 27 which is disposed in the retaining slidable sleeve 25. The deadbolt 24 is operable to slide relative to the housing 21 between a locking position (referring to FIG. 2), where the retaining end (25a) of the retaining slidable sleeve 25 projects outwardly from the opening 212, and an unlocking position (referring to FIG. 6), where the retaining end retreats into the deadbolt guiding slot 211. The driving member 28 is motionably disposed in the deadbolt guiding slot 211 and is operable by an external force to drive the deadbolt 24 to slide from the locking position to the unlocking position. With such arrangement of the housing 21, the deadbolt 24 and the driving member 28, the door lock kit 110 has a fewer number of components, which is easier to fabricate and has a simple and compact structure, thereby reducing the manufacturing costs thereof.

Specifically, the housing 21 includes a first housing part 22 and a second housing part 23 coupled with the first housing part 22. The first housing part 22 is made of metal material and is integrally formed as a single piece. The first housing part 22 has an end plate 221 which is formed with the opening 212, and a first housing half 222 which is integrally formed with an end of the end plate 221. The end plate 221 is an elongated plate and is elongated in the vertical direction (D3). The end plate 221 further has two through holes 223 respectively formed at upper and lower sides of the opening 212. The opening 212 is a square hole, for example. A screw 13 extends through each through hole 223 to secure the end plate 221 on the door panel 11. The end plate 221 has two long side edges 224 opposite to each other in the second horizontal direction (D2). Each long side edge 224 has two engaging grooves 225 opposite to each other in the vertical direction (D3). The first housing half 222 extends in the first horizontal direction (D1) and surrounds a right half part of the opening 212. A plurality of threaded studs 226, 226′, 226″ are formed on an inner housing wall surface of the first housing half 222 and are spaced apart from each other. The first housing half 222 has a pivot hole 227.

The second housing part 23 is made of metal material and is integrally formed as a single piece. The second housing part 23 surrounds a left half part of the opening 212 and extends in the first horizontal direction (D1), and has a second housing half 230 which is coupled with a left end of the first housing half 222. The second housing half 230 has a plurality of fastening holes 231 for the threaded studs 226, 226′, 226″ to extend therethrough, and a pivot hole 232 aligned with the pivot hole 227. Each threaded stud 226, 226′, 226″ partially projects from the second housing half 230 for a screw nut (not shown) to be engaged therewith so as to fasten the second housing half 230 to the first housing half 222. Thus, the end plate 221, the first housing half 222 and the second housing half 230 cooperatively define the deadbolt guiding slot 211. The deadbolt guiding slot 211 extends along the first horizontal direction (D1) for guiding the sliding movement of the deadbolt 24 along the first horizontal direction (D1) between the locking position and the unlocking position.

With the first housing part 22 being made of a metal material and integrally formed as a single piece, the first housing part 22 has a great structural strength. Additionally, the housing 21 only includes the first housing part 22 and the second housing part 23, which has a fewer number of components and is easier to assemble.

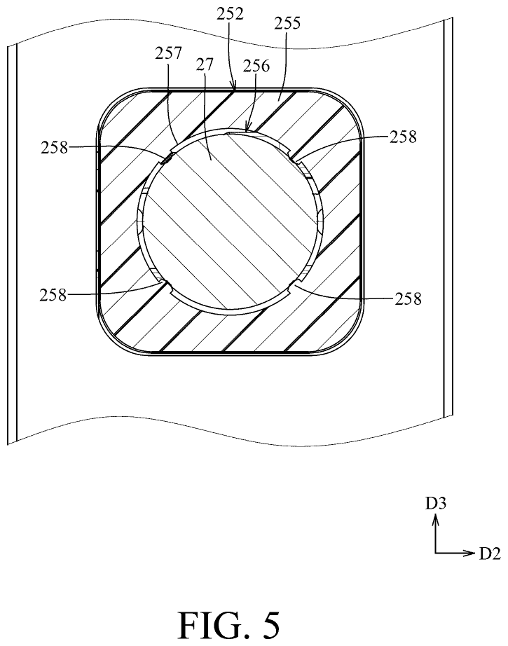

With reference to FIGS. 2, 3, 4 and 5, the retaining slidable sleeve 25 is integrally formed as a single piece. In this embodiment, the retaining slidable sleeve 25 is made of a nylon material so that it may be operated silently. The retaining slidable sleeve 25 has a sleeve 250 which is disposed in the deadbolt guiding slot 211 and which has the retaining end 25a projecting outwardly from the opening 212, and a sliding rod 251 which is integrally formed with and extends in a first horizontal direction (D1) from an end of the sleeve 250 opposite to the retaining end 25a. The sleeve 250 has a sleeve wall 252 and a flange 253. The sleeve wall 252 is a generally rectangular cylinder and is sleeved around the magnet 27. The sleeve wall 252 has an end wall 254 which serves as the retaining end 25a, and a cylindrical wall 255 which is connected with the end wall 254 to cooperatively define an accommodation chamber 256 for accommodating the magnet 27 therein. The accommodation chamber 256 is of a circular slot, for example.

The magnet 27 may be cylindrical. The cylindrical wall 255 has an inner sleeve wall surface 257 surrounding and defining the accommodation chamber 256, and a plurality of press-fit ribs 258 projecting from and formed on the inner sleeve wall surface 257 and angularly spaced apart from each other to be in press-fit engagement with the magnet 27. The flange 253 extends radially from the cylindrical wall 255 at the end opposite to the end wall 254, and is disposed in the deadbolt guiding slot 211.

In mounting the magnet 27 to the retaining slidable sleeve 25, the magnet 27 is inserted into the accommodation chamber 256 and abuts against the end wall 254. The magnet 27 is retainingly received in the accommodation chamber 256 by the press-fit ribs 258 so that loosening and undesired disengagement of the magnet 27 may be prevented. Additionally, with the magnet 27 abutting against the end wall 254, a good magnetic force on the deadbolt 24 is maintained at the end wall 254.

In the embodiment, the accommodation chamber 256 extends along the first horizontal direction (D1). Each press-fit rib 258 is in the form of an elongated rib which extends along the first horizontal direction (D1). Thus, each press-fit rib 258 has a large contact area with the magnet 27 in the first horizontal direction (D1) to increase the retaining force of the press-fit rib 258 to the magnet 27 so as to retain the magnet 27 firmly in the accommodation chamber 256 without swaying.

The sliding rod 251 is integrally formed with and extends in the first horizontal direction (D1) from an end of the cylindrical wall 255 of the sleeve 250 opposite to the end wall 254. The sliding rod 251 is coupled with and driven by the driving member 28. Specifically, the sliding rod 251 extends along the first horizontal direction (D1), and has a first driven surface 259 and a second driven surface 260 which is spaced apart from the first driven surface 259 in the first horizontal direction (D1) and in the second horizontal direction (D2). The second driven surface 260 is interposed between the sleeve 250 and the first driven surface 259. In the embodiment, the sliding rod 251 is formed with a first notch 261 and a second notch 262 recessed from a side thereof. The second notch 262 is in spatial communication with the first notch 261. The first driven surface 259 borders a portion of the first notch 261, and the second driven surface 260 borders a portion of the second notch 262. Thus, a width of the sliding rod 251 in the second horizontal direction (D2) is reduced to minimize the volume of the sliding rod 251.

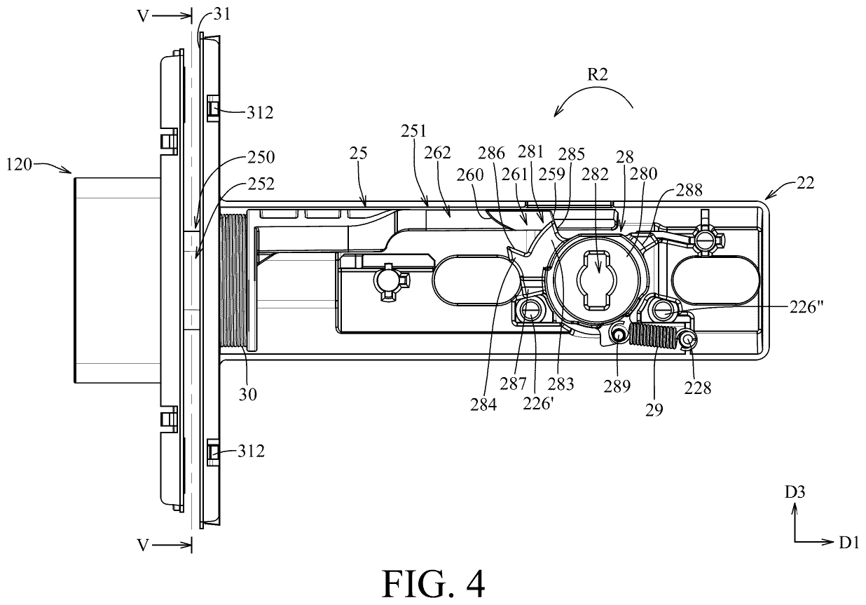

With reference to FIGS. 2, 3, 4 and 6, the driving member 28 has a pivot cylinder 280 and a driving arm 281. The pivot cylinder 280 is rotatably engaged in the pivot hole 227 of the first housing half 22 and the pivot hole 232 of the second housing half 23 to be pivotably connected with the housing 21 about a pivot axis extending in the second horizontal direction (D2). The pivot cylinder 280 has a penetrating hole 282 for insertion of a lock cylinder (not shown). For example, the lock cylinder is connected with an electric motor (not shown) which is actuated to rotate the lock cylinder to bring rotation of the driving member 28 with the lock cylinder. The driving arm 281 is formed on and extends radially from an outer cylindrical surface of the pivot cylinder 280 to press the sliding rod 251 to move the deadbolt 24 along the first horizontal direction (D1) to the unlocking position when the pivot cylinder 280 is rotated relative to the housing 21 about the pivot axis. Specifically, the driving arm 281 has a first arm portion 283 and a second arm portion 284. The first arm portion 283 is movably disposed in the first notch 261, and has a first driving surface 285 at an end thereof for pressing the first driven surface 259. The second arm portion 284 extends from an opposite end of the first arm portion 283 away from the first driving surface 285, and is movably disposed in the second notch 262. The second arm portion 284 has a second driving surface 286 which is angularly spaced apart from the first driving surface 285 for pressing the second driven surface 260. The driving member 28 is rotatable relative to the housing 21 between an initial position (referring to FIG. 4) and a blocking position (referring to FIG. 6). In the initial position, the driving arm 281 is free from blocking the sliding rod 251 to permit the deadbolt 24 to slide to the locking position. In the blocking position, the driving arm 281 blocks the sliding rod 251 to retain the deadbolt 24 in the unlocking position.

A first threaded stud 226′ and a second threaded stud 226″ are spaced apart from each other in the first horizontal direction (D1) and are disposed at front and rear sides of the pivot hole 227, respectively. The driving member 28 further has a first abutting protrusion 287 and a second abutting protrusion 288 which extends radially from the outer cylindrical surface of the pivot cylinder 280 and which are angularly spaced apart from each other. The first abutting protrusion 287 is formed at an end of the second arm portion 284 away from the second driving surface 286. The first abutting protrusion 287 is for abutting against the first threaded stud 226′ to keep the driving member 28 in the initial position (see FIG. 4). The second abutting protrusion 288 is for abutting against the second threaded stud 226″ to keep the driving member 28 in the blocking position (see FIG. 6).

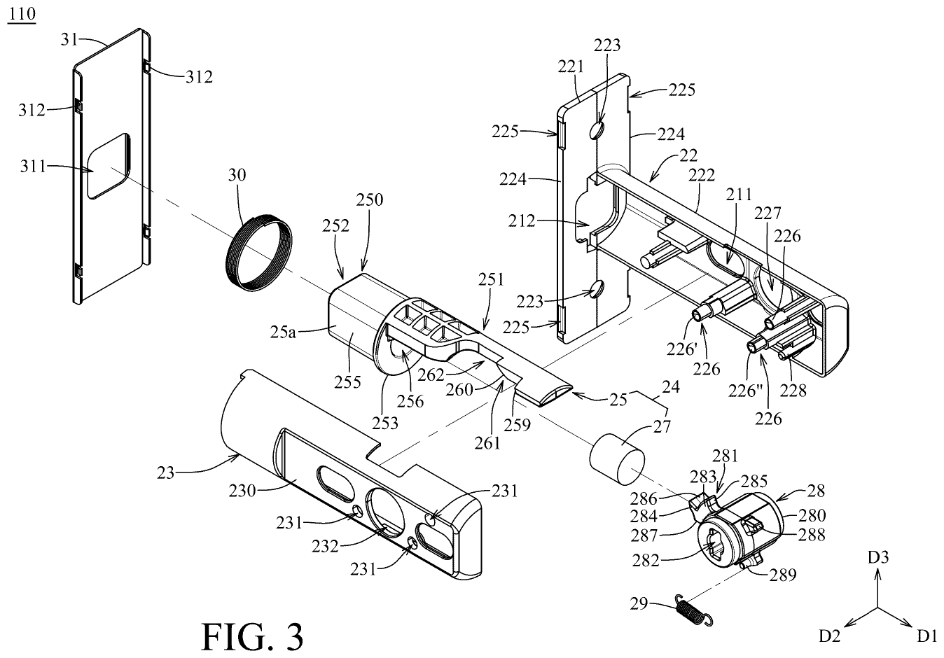

With reference to FIGS. 3, 4 and 6, the door lock kit 110 further includes a spring 29 connected between the housing 21 and the driving member 28 to generate a biasing returning force when the driving member 28 is moved to the blocking position. The biasing returning force of the spring 29 biases the deadbolt 25 to slide toward the locking position when the driving member 28 is free from blocking the retaining slidable sleeve 25. In the embodiment, the first housing half 222 has a connecting stud 228. The driving member 28 has a connecting stud 289 projecting from the outer cylindrical surface of the pivot cylinder 280. The spring 29 is a tension spring which has two ends connected with the connecting studs 228, 289, respectively.

With reference to FIGS. 2, 3 and 4, the door lock kit 110 further includes a buffering ring 30 which is sleeved around the sleeve wall 252 of the sleeve 25 and in abutting engagement with the housing 21 and the flange 253. For example, the buffering ring 30 is made of an elastomeric material, such as rubber, silicone, etc. The buffering ring 30 is interposed between the end plate 221 and the flange 253 so as to avoid contact of the flange 253 with the end plate 221 for buffering purposes.

The door lock kit 110 further includes a decorative plate 31 which is mounted on the end plate 221 to conceal the screw 13. In the embodiment, the decorative plate 31 has an opening 311 in spatial communication with the opening 212. The decorative plate 31 includes a plurality of snap-fit fasteners 312 which are respectively engaged with the engaging grooves 225 to fasten the decorative plate 31 to the end plate 221.

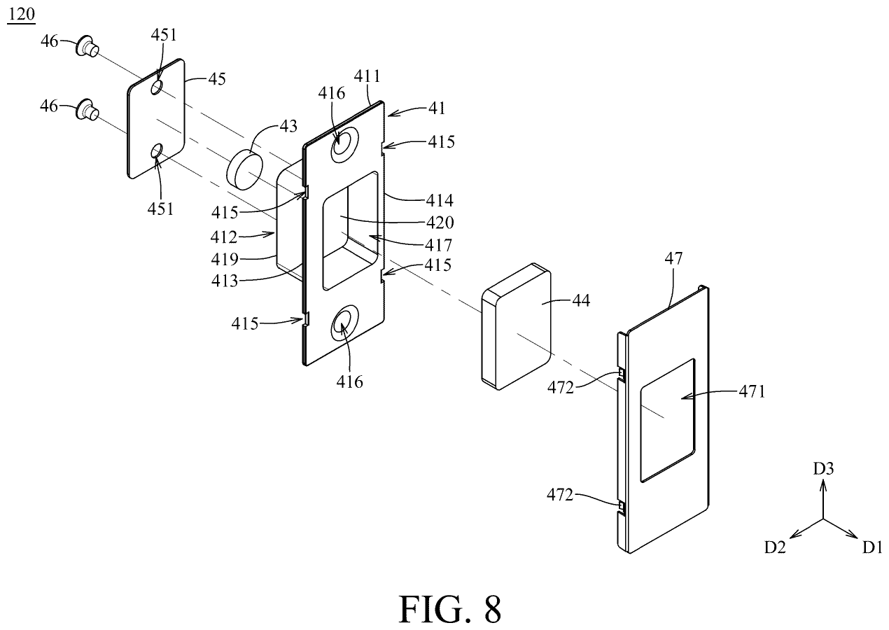

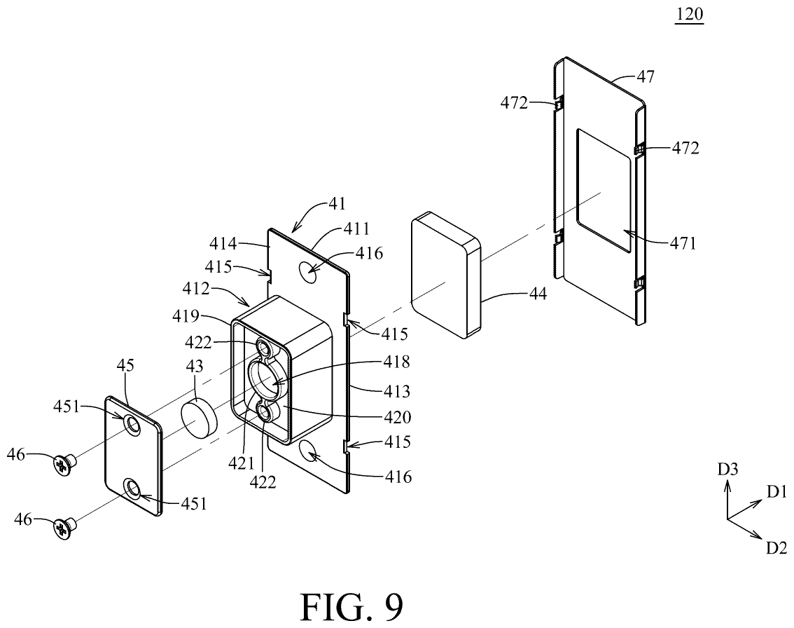

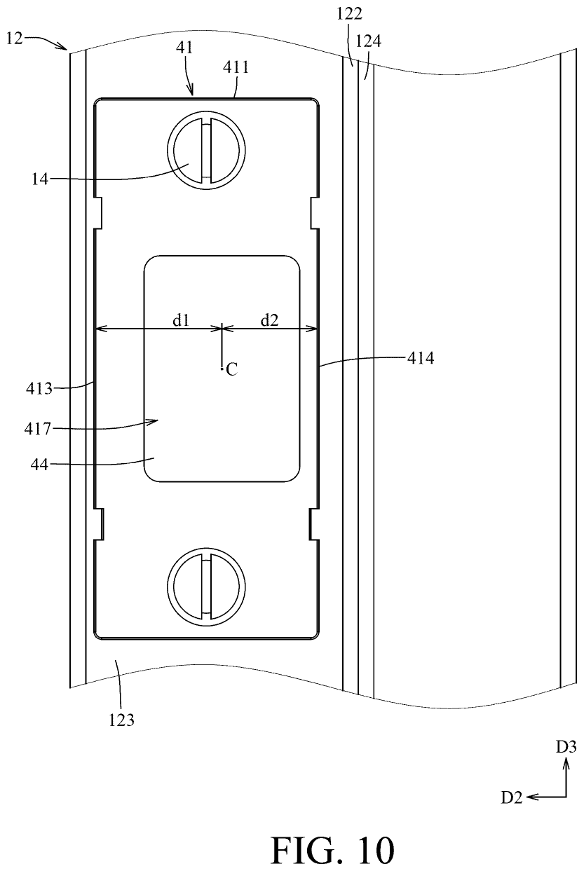

With reference to FIGS. 2, 7, 8, 9 and 10, the door frame lock kit 120 includes a lock frame 41, a magnet 43, a muffler member 44, a cover plate 45, a plurality of threaded bolts 46 and a decorative plate 47. The lock frame 41 including a locking plate 411 and a receptacle 412. The locking plate 411 is an elongated plate extending in the vertical direction (D3) for abutting against the upright side wall 123 of the door frame 12. The locking plate 411 has a first long side edge 413 and a second long side edge 414 opposite to each other in the second horizontal direction (D2). Each long side edge 413, 414 has two engaging grooves 415 opposite to each other in the vertical direction (D3). The locking plate 411 has two through holes 416 opposite to each other in the vertical direction (D3) and respectively aligned with the screw holes 126. A screw 14 extends through the corresponding through hole 416 and is threadedly engaged with the corresponding screw hole 126 to fasten the locking plate 411 on the upright side wall 123.

The receptacle 412 extends from a back surface of the locking plate 411 and is spaced apart from the first long side edge 413 and the second long side edge 414 in the second horizontal direction (D2). The receptacle 412 defines a center (C) which is distant from the first long side edge 413 by a first distance (d1), and which is distant from the second long side edge 414 by a second distance (d2). The first distance (d1) is larger than the second distance (d2). The receptacle 412 and the locking plate 411 cooperatively define a front receiving slot 417 therein for receiving the retaining end 25a of the retaining slidable sleeve 25 when the deadbolt 24 is in the locking position. The receptacle 412 is formed with a back receiving slot 418 which is remote from the locking plate 411 for receiving the magnet 43 therein. The magnet 43 is magnetically attracted to the magnet 27 of the deadbolt 24 to urge the retaining slidable sleeve 25 of the deadbolt 24 to slide into the front receiving slot 417 in the locking position.

Specifically, the receptacle 412 has an outer surrounding wall 419 extending from the back surface of the locking plate 411 and through the mounting hole 125 of the door frame 12, a partition wall 420 connected with an inner wall surface of the outer surrounding wall 419 and disposed parallel to the locking plate 411, an inner peripheral wall 421 extending from a back surface of the partition wall 420, and a plurality of threaded sockets 422 disposed on and projecting from the back surface of the partition wall 420. The locking plate 411, the outer surrounding wall 419 and the partition wall 420 cooperatively define the front receiving slot 417 thereamong. The partition wall 420 and the inner peripheral wall 421 cooperatively define the back receiving slot 418 therebetween.

The muffler member 44 is made of sound absorbing foam, and is disposed in the front receiving slot 417 and attached to a front surface of the partition wall 420. The muffler member 44 is disposed to contact with the sleeve wall 252 of the sleeve 250 for shock and sound absorbing purposes. The cover plate 45 is connected with the outer surrounding wall 419 and covers the back receiving slot 418 to conceal the magnet 43. The cover plate 45 is formed with a plurality of through holes 451 respectively aligned with the threaded sockets 422. Each threaded bolt 46 extends through the corresponding through hole 451 and is threadedly engaged with the corresponding threaded socket 422. With the cover plate 45 concealing the magnet 43, the magnet 43 is prevented from being exposed and disengaged from the back receiving slot 418.

The decorative plate 47 is mounted on the locking plate 411 of the lock frame 41 and conceals the screws 14. In the embodiment, the decorative plate 47 has an opening 471 in spatial communication with the front receiving slot 417. The decorative plate 47 includes a plurality of snap-fit fasteners 472 which are respectively engaged with the engaging grooves 415 to fasten the decorative plate 47 to the locking plate 411.

With reference to FIGS. 2 and 4, when the door panel 11 is in a closed position relative to the door frame 12, the spring 29 urges the driving member 28 to have the first abutting protrusion 287 abut against the first threaded stud 226′ to keep the driving member 28 in the initial position. At this stage, the first arm portion 283 of the driving arm 281 is partially extended into the first notch 261, the first driving surface 285 abuts against the first driven surface 259, and the second arm portion 284 is located below the sliding rod 251. With the magnet 43 of the door frame lock kit 120 being magnetically attracted to the magnet 27 of the deadbolt 24, the deadbolt 24 is kept in the locking position, where the retaining end (25a) of the retaining slidable sleeve 25 is engaged in the front receiving slot 417. Therefore, the door panel 11 is locked to the door frame 12 by the magnetic door lock 100.

With reference to FIGS. 2, 4 and 6, when it is desired to open the door panel 11, through the operation of the electric motor to rotate the lock cylinder, the driving member 28 is rotated in a first rotational direction (R1), and the first driving surface 285 presses the first driven surface 259 to move the deadbolt 24 forwardly along the first horizontal direction (D1). The retaining end 25a is moved from the front receiving slot 417 and retreats into the deadbolt guiding slot 211 so as to move the deadbolt 24 to the unlocking position. When the driving member 28 is rotated to a predetermined angle, the second arm portion 284 is partially extended into the second notch 262. Then, the second driving surface 286 of the second arm portion 284 abuts against and presses the second driven surface 260 to further move the deadbolt 24 forwardly along the first horizontal direction (D1). During this rotation of the driving member 28 in the first rotational direction (R1), the connecting stud 289 pulls the spring 29 so as to generate the biasing returning force. The rotation of the driving member 28 is stopped when the second abutting protrusion 288 abuts against the second threaded stud 226″ to keep the driving member 28 in the blocking position. At this stage, the second driven surface 260 of the sliding rod 251 is blocked by the second driving surface 286 of the driving member 28 so as to retain the deadbolt 24 in the unlocking position, where the retaining end 25a retreats into the deadbolt guiding slot 211. Thus, the door panel 11 is openable from the closed position.

When the door panel 11 is rotated back to the closed position, the electric motor is powered off to bring the lock cylinder to a released state. At this stage, the driving member 28 is rotated in a second rotational direction (R2) opposite to the first rotational direction (R1) by the biasing returning force of the spring 29. The rotation of the driving member 28 is stopped when the first abutting protrusion 287 abuts against the first threaded stud 226′ to keep the driving member 28 in the initial position. Meanwhile, with the magnet 43 being magnetically attracted to the magnet 27 of the deadbolt 24, the deadbolt 24 slides along the first horizontal direction (D1) to have the retaining end 25a project outwardly and engage in the front receiving slot 417 to the locking position.

With the buffering ring 30 and the muffler member 44 being in contact with the flange 253 and the sleeve wall 252, shock and sound absorbing effects are obtained during the movement of the deadbolt 24 to the locking position. With the spring 29 urging the driving member 28 back to the initial position, and the magnetic attraction of the magnet 43, the deadbolt 24 is slid automatically back to the locking position without actuation of the electric motor, which saves power.

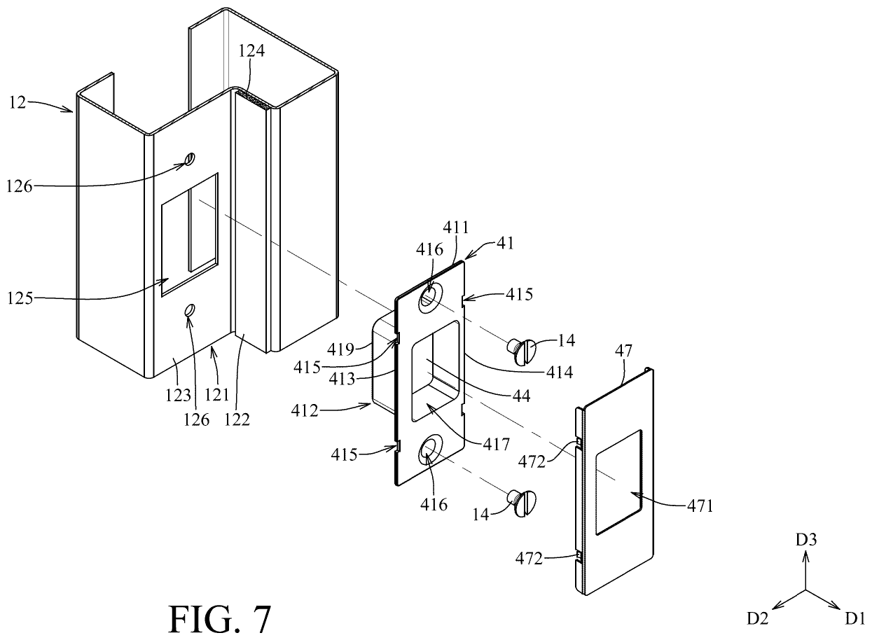

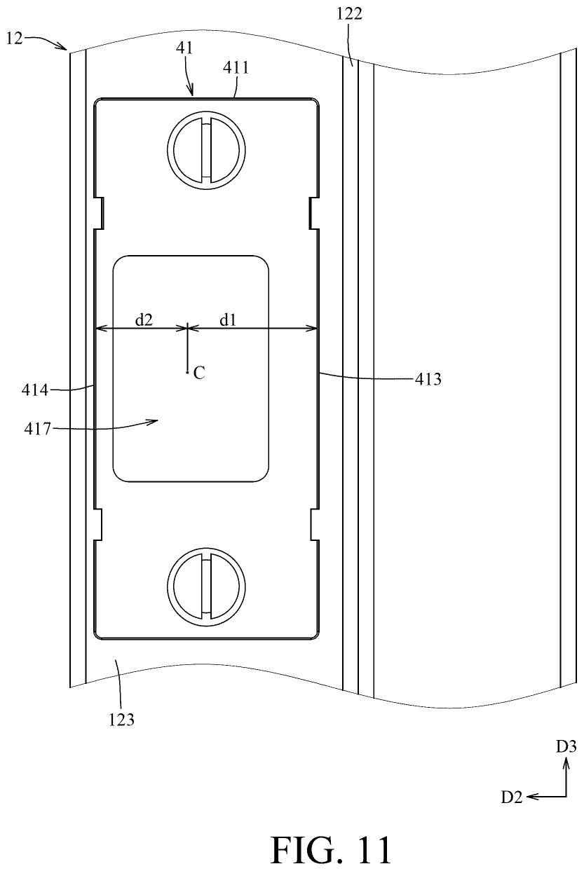

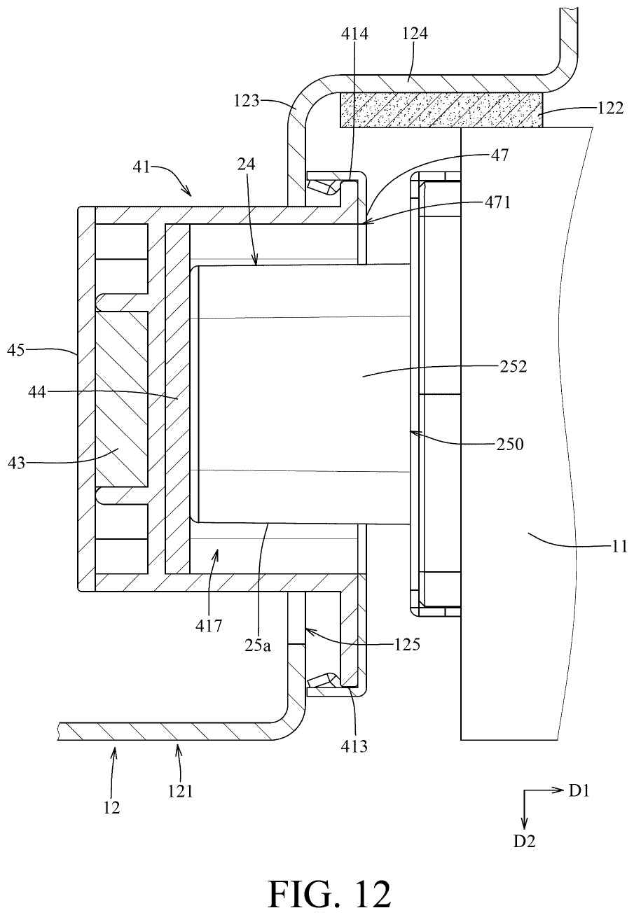

With reference to FIGS. 7, 10, 11 and 12, with the first distance (d1) measured between the center (C) of the receptacle 412 and the first long side edge 413 being larger than the second distance (d2) measured between the center (C) and the second long side edge 414, there are two methods to assemble the lock frame 41 on the door frame 12 according to the position and dimension of the rubber strip 122. In the first method, the second long side edge 414 is disposed proximal to the rubber strip 122 on the upright side wall 123. In the second method, the first long side edge 413 is disposed proximal to the rubber strip 122 on the upright side wall 123. For example, in case of a thinner rubber strip 122, the first method is selected to position the receptacle 412 and the front receiving slot 417 closer to the rubber strip 122. In case of a thicker rubber strip 122, the second method is selected to position the receptacle 412 and the front receiving slot 417 farther away from the rubber strip 122. Thus, the door panel 11 is in press-fit engagement with the rubber strip 122 in the closed position to avoid swaying.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A door lock kit, comprising:
a housing formed with a deadbolt guiding slot therein, and an opening in communication with said deadbolt guiding slot;
a deadbolt including a retaining slidable sleeve which is slidably disposed in said deadbolt guiding slot and which has a retaining end that faces toward said opening, and a magnet which is disposed in said retaining slidable sleeve, said deadbolt being operable to slide relative to said housing between a locking position, where said retaining end of said retaining slidable sleeve projects outwardly from said opening, and an unlocking position, where said retaining end retreats into said deadbolt guiding slot; and
a driving member motionably disposed in said deadbolt guiding slot and operable by an external force to drive said deadbolt to slide from the locking position to the unlocking position.

2. The door lock kit of claim 1, wherein said retaining slidable sleeve has a sleeve which is disposed in said deadbolt guiding slot to project outwardly from said opening, and a sliding rod which is integrally formed with and extends in a first horizontal direction from said sleeve, said sleeve defining an accommodation chamber for accommodating said magnet therein, said sliding rod being coupled with and driven by said driving member.

3. The door lock kit of claim 1, wherein said retaining slidable sleeve is formed with an accommodation chamber for accommodating said magnet therein, said retaining slidable sleeve having an inner sleeve wall surface surrounding and defining said accommodation chamber, and a plurality of press-fit ribs projecting from and formed on said inner sleeve wall surface and angularly spaced apart from each other to be in press-fit engagement with said magnet.

4. The door lock kit of claim 3, wherein said accommodation chamber extends along a first horizontal direction, each of said press-fit ribs being in form of an elongated rib which extends along the first horizontal direction.

5. The door lock kit of claim 3, wherein said retaining slidable sleeve has an end wall which serves as said retaining end, and a cylindrical wall which is connected with said end wall and which has said inner sleeve wall surface, said magnet abutting against said end wall, said cylindrical wall and said end wall cooperatively defining said accommodation chamber.

6. The door lock kit of claim 1, wherein said deadbolt is slidable relative to said housing along a first horizontal direction between the locking position and the unlocking position, said retaining slidable sleeve having a sleeve which is sleeved around said magnet and disposed in said deadbolt guiding slot to project outwardly from said opening, and a sliding rod which is integrally formed with and extends in the first horizontal direction from an end of said sleeve, said driving member having a pivot cylinder which is pivotably connected with said housing about a pivot axis, and a driving arm which is formed on and extends radially from an outer cylindrical surface of said pivot cylinder, said driving arm pressing said sliding rod to move said deadbolt along the first horizontal direction to the unlocking position when said pivot cylinder is rotated relative to said housing about the pivot axis.

7. The door lock kit of claim 6, wherein said sliding rod has a first driven surface and a second driven surface which is spaced apart from said first driven surface in the first horizontal direction and in a second horizontal direction that is transverse to the first horizontal direction, said second driven surface being interposed between said sleeve and said first driven surface, said driving arm having a first driving surface and a second driving surface which is angularly spaced apart from said first driving surface, said first driving surface abutting against said first driven surface when said deadbolt is in the locking position to press said first driven surface to move said deadbolt toward the unlocking position, said second driving surface abutting against and pressing said second driven surface during movement of said deadbolt.

8. The door lock kit of claim 7, wherein said driving arm has a first arm portion and a second arm portion, said first arm portion having said first driving surface formed at an end thereof, said second arm portion extending from an opposite end of said first arm portion away from said first driving surface, and having said second driving surface, said sliding rod being formed with a first notch for said first arm portion to be movably disposed therein, and a second notch in spatial communication with said first notch for said second arm portion to be movably disposed therein, said first driven surface bordering a portion of said first notch, said second driven surface bordering a portion of said second notch.

9. The door lock kit of claim 6, wherein said driving member is rotatable relative to said housing between an initial position and a blocking position, wherein, in the initial position, said driving arm is free from blocking said sliding rod to permit said deadbolt to slide to the locking position, and in the blocking position, said driving arm blocks said sliding rod to retain said deadbolt in the unlocking position.

10. The door lock kit of claim 1, wherein said retaining slidable sleeve has a sleeve wall which is sleeved around said magnet and disposed in said deadbolt guiding slot and which has a retaining end projecting outwardly from said opening, and a flange which extends radially from an opposite end of said sleeve wall opposite to said retaining end, said door lock kit further comprising a buffering ring which is sleeved around said sleeve wall and in abutting engagement with said housing and said flange.

11. The door lock kit of claim 1, wherein said housing includes a first housing part and a second housing part coupled with said first housing part, said first housing part being made of a metal material and integrally formed as a single piece, said first housing part having an end plate which is formed with said opening, and a first housing half which is integrally formed with an end of said end plate, said second housing part having a second housing half which is coupled with said first housing half to cooperatively define said deadbolt guiding slot.

12. The door lock kit of claim 11, further comprising a decorative plate which is mounted on said end plate, said decorative plate having a plurality of snap-fit fasteners to be fastened to said end plate.

13. The door lock kit of claim 1, further comprising a spring connected between said housing and said driving member to generate a biasing returning force when said driving member is moved to a blocking position, where said driving member blocks said retaining slidable sleeve to retain said deadbolt in the unlocking position, such that said biasing returning force biases said deadbolt to slide toward the locking position when said driving member is free from blocking said retaining slidable sleeve.

14. The door lock kit of claim 1, wherein said retaining slidable sleeve is made of a nylon material and is integrally formed as a single piece.

15. A door frame lock kit comprising:
a lock frame including a locking plate and a receptacle cooperatively defining a front receiving slot therein, said locking plate having a first long side edge and a second long side edge opposite to each other, said receptacle extending from said locking plate and being spaced apart from said first long side edge and said second long side edge, said receptacle defining a center which is distant from said first long side edge by a first distance, and which is distant from said second long side edge by a second distance, said first distance being larger than said second distance; and
a magnet disposed in said receptacle.

16. The door frame lock kit of claim 15, wherein said receptacle is formed with a back receiving slot which is remote from said locking plate for receiving said magnet therein, said door frame lock kit further comprising a muffler member which is disposed in said front receiving slot.

17. The door frame lock kit of claim 16, wherein said receptacle has an outer surrounding wall extending from a back surface of said locking plate, a partition wall connected with an inner wall surface of said outer surrounding wall and disposed parallel to said locking plate, and an inner peripheral wall extending from a back surface of said partition wall, wherein, said locking plate, said outer surrounding wall and said partition wall cooperatively define said front receiving slot thereamong, and said partition wall and said inner peripheral wall cooperatively define said back receiving slot therebetween.

18. The door frame lock kit of claim 17, wherein said receptacle further has a plurality of threaded sockets disposed on and projecting from said back surface of said partition wall, said door frame lock kit further comprising a cover plate which is connected with said outer surrounding wall and covers said back receiving slot to conceal said magnet, and a plurality of threaded bolts, said cover plate being formed with a plurality of through holes respectively aligned with said threaded sockets, each of said threaded bolts extending through a respective one of said through holes and being threadedly engaged with said respective threaded socket.

19. The door frame lock kit of claim 15, further comprising a decorative plate which is mounted on said locking plate, said decorative plate having a plurality of snap-fit fasteners to be fastened to said locking plate.

20. A magnetic door lock comprising:
a door lock kit including a housing, a deadbolt and a driving member, said housing being formed with a deadbolt guiding slot therein, and an opening in communication with said deadbolt guiding slot, said deadbolt including a retaining slidable sleeve which is slidably disposed in said deadbolt guiding slot and which has a retaining end that faces toward said opening, and a magnet which is disposed in said retaining slidable sleeve, said deadbolt being operable to slide relative to said housing between a locking position, where said retaining end of said retaining slidable sleeve projects outwardly from said opening, and an unlocking position, where said retaining end retreats into said deadbolt guiding slot, said driving member motionably being disposed in said deadbolt guiding slot and being operable by an external force to drive said deadbolt to slide from the locking position to the unlocking position; and
a door frame lock kit including a lock frame and a magnet, said lock frame including a locking plate and a receptacle cooperatively defining a front receiving slot therein, said locking plate having a first long side edge and a second long side edge opposite to each other, said receptacle extending from said locking plate and being spaced apart from said first long side edge and said second long side edge, said receptacle defining a center which is distant from said first long side edge by a first distance, and which is distant from said second long side edge by a second distance, said first distance being larger than said second distance, said magnet being disposed in said receptacle,
wherein said magnet of said door frame lock kit is magnetically attracted to said magnet of said deadbolt to urge said retaining slidable sleeve of said deadbolt to slide into said front receiving slot in the locking position.
